(19) United States
(12) Patent Application Publication
(10) Pub. No.: US 2005/0131198 A1
(43) Pub. Date: Jun. 16, 2005

(54) Polyoxymethylene-made stretched product and production method thereof

(75) Inventor: Hidetoshi Okawa, Fuji-shi (JP)

Correspondence Address: NIXON & VANDERHYE, PC, 1100 N GLEBE ROAD, 8TH FLOOR, ARLINGTON, VA, 22201-4714, US

(73) Assignee: Polyplastics Co., Ltd., Tokyo (JP)

(21) Appl. No.: 10/733,774

(22) Filed: Dec. 12, 2003

(51) Int. Cl. B65D 1/00; C08G 16/00

(52) U.S. Cl. 528/230; 428/35.7

(57) ABSTRACT

A stretched product comprising a polyoxymethylene copolymer and having high strength and high elastic modulas is provided. A polyoxymethylene copolymer having a melt index (190° C., load: 2160 g) of from 0.3 to 20 g/10 min and containing, in the polymer chain mainly comprising an oxymethylene repeating unit, a specific oxyalkylene unit in an amount of from 0.5 to 10 mol per 100 mol of the oxymethylene unit is melt-extruded to obtain a rod-like or hollow molded article and then the molded article is stretched under heating, thereby obtaining a stretched product having a sectional area of from 0.003 to 700 mm².

### TECHNICAL FIELD TO WHICH THE INVENTION BELONGS

The present invention relates to a stretched product comprising a polyoxymethylene copolymer and a production method thereof.

### BACKGROUND ART

Most of conventional resinous stretched products comprise a polyolefin resin such as polypropylene and polyethylene. These are inexpensive and therefore, have been widely utilized for many applications including building materials. However, since a polyolefin resin has low crystallinity, a stretched product thereof has a limit on the strength after stretching and the strength may be insufficient depending on the application. Further, recent demands for a stretched product having higher strength or demands for a secondary processed product such as a woven fabric or a geogrid comprising such a stretched product cannot be sufficiently satisfied.

On the other hand, polyoxymethylene is a polymer having a polymer skeleton mainly comprising an oxymethylene repeating unit, and it is known that the resin is high in the degree of crystallinity, and excellent in view of rigidity, strength, chemical resistance, solvent resistance and the like. Further, the resin is fast in the speed of crystallization and in the molding cycle and therefore, is being widely used mainly as injection molding materials in the fields of mechanical parts of automobiles and electrical appliances. Further, it is known that the polyoxymethylene has high crystallinity and therefore, is formed as a high strength and high elastic body due to orientation crystallization by stretching (see, e.g., “high strength/high elastic modulus fiber” compiled by Society of Polymer Science, Kyoritsu Shuppan, p.48, published 1988).

As described above, the polyoxymethylene is a resin having various excellent properties. However, it presents a certain type of restriction on the molding processing method because of high crystallinity. For example, there is a problem that in a stretching step of film, fiber, wire rods, and the like, cutting is liable to occur due to occurrence of voids within fibrils, therefore, productivity cannot be elevated and a practical stretched product having high strength is hardly obtained. Further, it is heretofore considered that the polyoxymethylene is hardly applied to the production of a practical stretched product in view of its high degree of crystallinity or high speed of crystallization. Therefore, the resin has scarcely been studied excluding academic researches.

As a small number of conventional arts relating to such a polyoxymethylene stretched product, a method is known for performing stretching while applying pressure in a pressurized fluid (see, e.g., JP-A 60-183121 and JP-A 60-183122).

The technique disclosed in these documents is a method for performing stretching in a pressurized fluid mainly using silicone oil, etc., in order to improve stretchability. In this method, a special stretching facility is required to keep the fluid in a pressurized condition, and a step of washing a stretched product after stretching to remove the pressurized fluid such as silicone oil is also required. Therefore, it cannot be said that the technique has high productivity. In these documents, a polyoxymethylene homopolymer is used in their Example. It is presumed that the homopolymer is deteriorated in the stretch-processability due to high crystallinity, and therefore, such a special stretching technique that stretching is performed in a pressurized fluid is carried out.

### DISCLOSURE OF THE INVENTION

The invention is to solve the above-described problems and to provide a stretched product comprising polyoxymethylene and having high strength and a high elastic modulus. Another object of the present invention is to provide its production method which is high in productivity efficiency.

As a result of extensive investigations so as to attain the above-described purposes, the present inventor has found that by using a particular polyoxymethylene copolymer controlled in the crystallinity speed, stretch-processability is improved, so that a stretched product having high strength, high elastic modulus, excellent solvent resistance, good heat resistance and superior flexural fatigue resistance can be obtained by a simple production method. The present invention has been accomplished based on this finding.

More specifically, the present invention is a polyoxymethylene-made stretched product comprising a polyoxymethylene copolymer and having a sectional area of from 0.003 to 700 mm², the polyoxymethylene copolymer having a melt index (190° C., load: 2160 g) of from 0.3 to 20 g/10 min and containing, in the polymer chain mainly comprising an oxymethylene repeating unit, an oxyalkylene unit represented by the following formula (1) in an amount of from 0.5 to 10 mol per 100 mol of the oxymethylene unit: 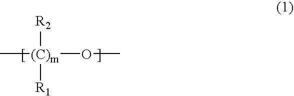
(wherein R₁ and R₂ each is selected from hydrogen, an alkyl group having from 1 to 8 carbon atoms, an organic group having an alkyl group with from 1 to 8 carbon atoms, a phenyl group, and an organic group having a phenyl group, R₁ and R₂ may be the same or different, and m represents an integer of from 2 to 6); and a method for producing a polyoxymethylene-made stretched product, comprising melt-extruding the above-described polyoxymethylene copolymer to obtain a rod-like or hollow molded article and then stretching the molded article under heating to obtain a stretched product having a sectional area of from 0.003 to 700 mm².

### DETAILED DESCRIPTION OF THE INVENTION

The present invention is described in detail below. First, the polyoxymethylene copolymer used for a polyoxymethylene-made stretched product of the present invention and the production method thereof are described.

In the stretched product of the present invention and the production method thereof, the polyoxymethylene copolymer containing, in the polymer chain mainly comprising an oxymethylene repeating unit, an oxyalkylene unit represented by the above-described formula (1) in an amount of from 0.5 to 10 mol per 100 mol of the oxymethylene unit is used.

In the polyoxymethylene copolymer for use in the present invention, a ratio of the oxyalkylene unit represented by formula (1) must be from 0.5 to 10 mol per 100 mol of the oxymethylene unit, preferably from 1.2 to 8 mol per 100 mol of the oxymethylene unit, particularly preferably from 2 to 6 mol per 100 mol of the oxymethylene unit. When the ratio of the oxyalkylene unit represented by formula (1) is decreased, the crystallinity degree of the polyoxymethylene copolymer is elevated, and as a result, cutting is liable to occur due to occurrence of voids within fibrils in the stretching step. When the ratio of the oxyalkylene unit represented by formula (1) is increased, the ultimate crystallinity degree is decreased, and as a result, a stretched product having high strength cannot be obtained.

Furthermore, in the polyoxymethylene copolymer for use in the present invention, a melt index (MI) measured at 190° C. under a load of 2160 g in accordance with ASTMD-1238 must be from 0.3 to 20 g/10 min, preferably from 0.5 to 10 g/10 min, particularly preferably from 0.5 to 5 g/10 min. When the melt index (MI) is too small, the load in the production of a rod-like or hollow molded article at the pre-step of the stretched product is increased, and as a result, the extrusion is hardly carried out. When the melt index (MI) is too large, the production of a rod-like or hollow molded article becomes unstable due to draw down of the resin.

The production method of the above-described polyoxymethylene copolymer for use in the present invention is not particularly limited. In general, it can be carried out by means of a bulk polymerization where trioxane and a cyclic ether compound or a cyclic formal compound as a comonomer are polymerized by mainly using a cationic polymerization catalyst to give the copolymer. As the polymerization apparatus, any of publicly known apparatuses such as a batch-type and continuous-type apparatus may be used. Here, the feeding ratio of the above shown oxyalkylene unit represented by formula (1) can be adjusted according to the amount of a comonomer to be copolymerized, and the melt index (MI) can be adjusted according to the added amount of a chain transfer agent such as methylal used during the polymerization.

Examples of the cyclic ether compound or the cyclic formal compound used as a comonomer include ethylene oxide, propylene oxide, butylene oxide, epichlorohydrin, epibromohydrin, styrene oxide, oxetane, 3,3-bis(chloromethyl)oxetane, tetrahydrofuran, trioxepane, 1,3-dioxolane, propylene glycol formal, diethylene glycol formal, triethylene glycol formal, 1,4-butanediol formal, 1,5-pentanediol formal and 1,6-hexanediol formal. Among them, ethylene oxide, 1,3-dioxolane, diethylene glycol formal and 1,4-butanediol formal are preferred. Further, the polyoxymethylene copolymer for use in the present invention may be one having a branched or cross-linked structure.

The polyoxymethylene copolymer obtained by polymerization is put into practical use by subjecting it to deactivation treatment of the catalysts, removal of unreacted monomers, washing and drying of polymers, a stabilizing treatment of unstable terminal parts, etc. and then, further subjecting it to stabilizing treatment by the blend of various stabilizers. Typical stabilizers include hindered phenolic compounds, nitrogen-containing compounds, alkali or alkali earth metal hydroxides, inorganic salts, and carboxylates.

In the thus-obtained polyoxymethylene copolymer for use in the present invention, the amount of hemiformal terminal group detected by means of ¹H-NMR is preferably from 0 to 4 mmol/kg, particularly preferably from 0 to 2 mmol/kg. When the amount of a hemiformal terminal group is more than 4 mmol/kg, a problem may arise such as foaming upon melt-processing caused by decomposition of the polymer. In order to control the amount of hemiformal terminal group within the above-described range, it is preferred that the impurities, particularly water, in the total amount of monomers and comonomers used for the polymerization are made to be 20 ppm or less or, particularly preferably, 10 ppm or less.

In addition, one or more of common additives for thermoplastic resin, such as coloring agent (e.g. dye and pigment), lubricant, nuclear agent, releasing agent, antistatic agent, surfactant, organic polymeric material and inorganic or organic filler in a form of fiber, plates or powder may be further added to the polyoxymethylene copolymer for use in the present invention, if necessary, as long as the object of the present invention is not impaired.

Next, the method for producing a stretched product using the polyoxymethylene copolymer as described above is described. The stretched product of the present invention is obtained by once forming a rod-like or hollow molded article from the polyoxymethylene copolymer as described above and then stretching the molded article under heating, preferably under normal pressure.

Here, although a method for forming a rod-like or hollow molded article is not particularly limited, a melting and extrusion process is commonly used. The melting and extrusion process is such a process that a resin is heated and melted within an extruder and then, the molten resin is extruded and molded from an extrusion molding nozzle having a desired shape. With respect to a sectional shape, an arbitrary shape can be designed in addition to a circular type.

The stretched product of the present invention is obtained by continuously or discontinuously stretching the thus-obtained rod-like or hollow molded article under heating, preferably under normal pressure. A heating method during the stretching is not also particularly limited. A method for passing the molded article through a high-temperature gas or liquid at normal pressure, a method for bringing the molded article into contact with a heating plate, or the like can be preferably used. Further, a specific stretching method is not also particularly limited. However, an example is a method for stretching the molded article between a plurality of rolls by controlling a speed ratio of the rolls provided in a high-temperature tub to adjust a stretching ratio.

In order to obtain a stretched product having a high stretching ratio, a multi-stage stretching method with two stages or more is desirable. The stretched product obtained by stretching treatment at a stretching step is desirably subjected to heat-fixing treatment where a molecular state is fixed in a heated condition, whereby a dimensional change of the stretched product can be reduced.

Here, the preferable stretching condition is that the stretched product is stretched by 2 to 40 times at a temperature of from the glass transition point to the melting point of the polyoxymethylene copolymer and the preferable heat-fixing condition is that the stretched product is heat-fixed at a temperature of from 120° C. to the melting point. Further, it is particularly preferable that the stretched product is uniaxially stretched by 2 to 40 times at a temperature of from 80 to 170° C. and heat-fixed at a temperature of from 120 to 180° C.

The polyoxymethylene-made stretched product of the present invention is used for various purposes utilizing its excellent properties such as high strength, high elastic modulus, solvent resistance, heat resistance, and flexural fatigue resistance. The stretched product has a rod-like shape and therefore, can be used as a material available in the fields of civil engineering and construction by processing it into a shape such as net in accordance with the intended use. For example, after the stretched product is coated with an arbitrary thermoplastic resin having a melting point of 150° C. or less, the coated stretched products are disposed in the form of a grid and the intersectional parts are adhered or welded to form a grid-like structure, whereby the resulting stretched products can be used also for geogrid purposes.

By the technique of the present invention, a polyoxymethylene-made stretched product typically having a sectional area of from 0.003 to 700 mm² can be obtained, and the sectional area is preferably from 0.005 to 300 mm².

Further, the stretched product can also be used by appropriately cutting it according to the purpose. For example, the product can be used as fibers or materials for concrete reinforcement. For such an application, a stretched product obtained by cutting it into 5 to 100 mm is preferable. By virtue of characteristics of the polyoxymethylene, these various products are excellent also in strength, rigidity and durability.

### EXAMPLES

The present invention is described in greater detail below by referring to Examples. However, the present invention is not limited thereto.

### Examples 1 to 11

A continuous mixing reactor was used which is composed of a barrel having a jacket for passing a hot/cold medium on its outside and shaped like partially overlapped two circles at its cross section, and rotating shafts equipped with a paddle. While each of the two rotating shafts having a paddle was rotated at 150 rpm, bulk polymerization was carried out to prepare the polymers having the comonomer amount shown in Table 1 by continuously supplying a polymerizing machine with liquefied trioxane, a cyclic ether or a cyclic formal (1,3-dioxolane, 1,4-butanediol formal or ethylene glycol formal) as a comonomer, together with methylal as a molecular weight regulator and simultaneously 50 ppm (based on the total monomers) of boron trifluoride as a catalyst. The reaction product discharged from the polymerizing machine was quickly passed through a disintegrator and, at the same time, it was added to an aqueous solution at 60° C. containing 0.05% by weight of triethylamine so that the catalyst was deactivated. This was further separated, washed and dried to obtain a crude polyoxymethylene copolymer.

Subsequently, to 100 parts by weight of this crude polyoxymethylene copolymer were added 4 parts by weight of a 5% by weight aqueous solution of triethylamine and 0.3 part by weight of pentaerythrityl-tetrakis[3-(3,5-di-tert-butyl-4-hydroxyphenyl) propionate] followed by subjecting the mixture to melting and kneading at 210° C. using a biaxial extruder to remove unstable parts.

To 100 parts by weight of the polyoxymethylene obtained by the above method were added 0.03 part by weight of pentaerythrityl-tetrakis[3-(3,5-di-tert-butyl-4-hydroxyphenyl) propionate] as a stabilizer and 0.15 part by weight of melamine followed by subjecting the mixture to melting and kneading at 210° C. using a biaxial extruder to obtain polyoxymethylene in a form of pellets.

Using the obtained polymer, it was continuously extruded through a die having a nozzle size of 3 mm and at a resin temperature of 200 to 220° C. by an extruder at a cylinder preset temperature of 200° C. to obtain a rod-like molded article having a circular cross section. This was stretched at a ratio shown in Table 1 in the longitudinal direction and was subjected to heat fixing treatment. The stretching was carried out under normal pressure in a hot air high-temperature furnace at 150° C. by controlling a speed ratio of roll winding and the heat fixing treatment was carried out at 160° C. for two seconds.

Evaluation results for the stretched products are shown in Table 1.

### Comparative Examples 1 to 5

In the same manner as in Examples, the polyoxymethylenes not specified in the present invention as shown in Table 1 were prepared to obtain the stretched products, followed by the evaluations. The results are shown in Table 1.

The evaluation standards and the like in Examples and Comparative Examples are as follows.

[Measurement of Melt Index (MI)]

The measurement was carried out at 190° C. and under a load of 2160 g in accordance with ASTMD-1238.

[Analysis of Polymer Composition]

The polymer used for evaluation of physical properties was dissolved in hexafluoroisopropanol-d2 and a ¹H-NMR measurement was carried out. Quantitative determination was conducted from the peak area corresponding to each unit.

[Analysis of Terminal Group]

The polymer used for evaluation of physical properties was dissolved in hexafluoroisopropanol-d2 and a ¹H-NMR measurement was carried out. Quantitative determination was conducted from the peak area corresponding to each terminal.

[Tensile Strength]

The measurement was carried out using a tensile tester.

TABLE 1

| | Polymer composition | | | | | Tensile |
|---|---|---|---|---|---|---|
| | Copolymerization | | MI | Hemiformal | Stretching | strength |
| | unit | Mol % | (g/10 min) | (mnol/kg) | ratio | (GPa) |
| Ex. 1 | (CH₂CH₂O) | 1.3 | 2 | 0.2 | 10 | 1.0 |
| Ex. 2 | (CH₂CH₂O) | 2.2 | 2 | 0.2 | 12 | 1.4 |
| Ex. 3 | (CH₂CH₂O) | 4.0 | 2 | 0.2 | 15 | 1.7 |
| Ex. 4 | (CH₂CH₂O) | 2.2 | 2 | 5 | 11 *1 | 1.2 *1 |
| Ex. 5 | (CH₂CH₂O) | 2.2 | 2 | 0.2 | 14 | 1.6 |
| Ex. 6 | (CH₂CH₂O) | 0.7 | 2 | 0.2 | 8 | 0.7 |
| Ex. 7 | (CH₂CH₂O) | 9.8 | 2 | 0.2 | 14 | 1.6 |
| Ex. 8 | (CH₂CH₂O) | 9.8 | 14 | 0.2 | 12 | 1.4 |
| Ex. 9 | (CH₂CH₂O) | 2.2 | 14 | 0.2 | 13 | 1.5 |
| Ex. 10 | (CH₂CH₂CH₂CH₂O) | 2.2 | 2 | 0.2 | 12 | 1.4 |
| Ex. 11 | (CH₂CH₂OCH₂CH₂O) | 2.2 | 2 | 0.2 | 12 | 1.4 |
| Comp. Ex. 1 | (CH₂CH₂O) | 0.48 | 2 | 0.2 | 4 | 0.3 |
| Comp. Ex. 2 | — | — | 2 | 0.2 | 3.5 | 0.3 |
| Comp. Ex. 3 | (CH₂CH₂O) | 2.2 | 27 | 0.2 | — *2 | — *2 |
| Comp. Ex. 4 | (CH₂CH₂O) | 2.2 | 0.2 | 0.2 | — *3 | — *3 |
| Comp. Ex. 5 | (CH₂CH₂O) | 4.0 | 45 | 0.2 | — *2 | — *2 |

*1 In the extrusion step, foaming is found and cutting easily occurs.
*2 Due to low melting viscosity, extrusion is hardly carried out and no rod-like molded article is obtained.
*3 Due to high melting viscosity, extrusion is hardly carried out and no rod-like molded article is obtained.

1. A polyoxymethylene-made stretched product comprising a polyoxymethylene copolymer and having a sectional area of from 0.003 to 700 mm², said polyoxymethylene copolymer having a melt index (190° C., load: 2160 g) of from 0.3 to 20 g/10 min and containing, in the polymer chain mainly comprising an oxymethylene repeating unit, an oxyalkylene unit represented by the following formula (1) in an amount of from 0.5 to 10 mol per 100 mol of the oxymethylene unit: 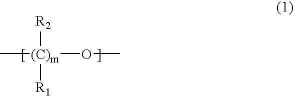
(wherein R₁ and R₂ each is selected from hydrogen, an alkyl group having from 1 to 8 carbon atoms, an organic group having an alkyl group with from 1 to 8 carbon atoms, a phenyl group, and an organic group having a phenyl group, R₁ and R₂ may be the same or different, and m represents an integer of from 2 to 6).

2. The polyoxymethylene-made stretchedproduct as claimed in claim 1, wherein the polyoxymethylene copolymer contains said oxyalkylene unit in an amount of from 1.2 to 8 mol per 100 mol of the oxymethylene unit.

3. The polyoxymethylene-made stretched product as claimed in claim 1, wherein the polyoxymethylene copolymer contains said oxyalkylene unit in an amount of from 2 to 6 mol per 100 mol of the oxymethylene unit.

4. The polyoxymethylene-made stretched product as claimed in claim 1 or 2, wherein the polyoxymethylene copolymer has a melt index of from 0.5 to 10 g/10 min.

5. The polyoxymethylene-made stretched product as claimed in claim 1 or 2, wherein the polyoxymethylene copolymer has a melt index of from 0.5 to 5 g/10 min.

6. The polyoxymethylene-made stretched product as claimed in claim 1 or 2, wherein the polyoxymethylene copolymer has a branched or cross-linked structure.

7. The polyoxymethylene-made stretched product as claimed in claim 1 or 2, wherein the polyoxymethylene copolymer has from 0 to 4 mmol/kg of a hemiformal terminal group.

8. The polyoxymethylene-made stretched product as claimed in claim 1 or 2, wherein the sectional area is from 0.005 to 300 mm².

9. A method for producing a polyoxymethylene-made stretched product, comprising melt-extruding a polyoxymethylene copolymer to obtain a rod-like or hollow molded article and then stretching the molded article under heating to obtain a stretched product having a sectional area of from 0.003 to 700 mm², said polyoxymethylene copolymer having a melt index (190° C., load: 2160 g) of from 0.3 to 20 g/10 min and containing, in the polymer chain mainly comprising an oxymethylene repeating unit, an oxyalkylene unit represented by the following formula (1) in an amount of from 0.5 to 10 mol per 100 mol of the oxymethylene unit: 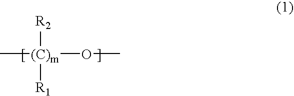
(wherein R₁ and R₂ each is selected from hydrogen, an alkyl group having from 1 to 8 carbon atoms, an organic group having an alkyl group with from 1 to 8 carbon atoms, a phenyl group, and an organic group having a phenyl group, R₁ and R₂ may be the same or different, and m represents an integer of from 2 to 6).

10. The method for producing a polyoxymethylene-made stretched product as claimed in claim 9, wherein the rod-like or hollow molded article obtained by the melt-extrusion is stretched under a normal pressure.

11. The method for producing a polyoxymethylene-made stretched product as claimed in claim 9 or 10, wherein the rod-like or hollow molded article obtained by the melt-extrusion is uniaxially stretched by 2 to 40 times at a temperature of from the glass transition point to the melting point of said polyoxymethylene copolymer.

12. The method for producing a polyoxymethylene-made stretched product as claimed in claim 9 or 10, wherein the rod-like or hollow molded article obtained by the melt-extrusion is uniaxially stretched by 2 to 40 times at a temperature of from the glass transition point to the melting point of said polyoxymethylene copolymer and heat-fixed at 120° C. or more.

13. The method for producing a polyoxymethylene-made stretched product as claimed in claim 9 or 10, wherein the polyoxymethylene copolymer contains said oxyalkylene unit in an amount of from 1.2 to 8 mol per 100 mol of the oxymethylene unit.

14. The method for producing a polyoxymethylene-made stretched product as claimed in claim 9 or 10, wherein the polyoxymethylene copolymer contains said oxyalkylene unit in an amount of from 2 to 6 mol per 100 mol of the oxymethylene unit.

15. The method for producing a polyoxymethylene-made stretched product as claimed in claim 9 or 10, wherein the polyoxymethylene copolymer has a melt index of from 0.5 to 10 g/10 min.

16. The method for producing a polyoxymethylene-made stretched product as claimed in claim 9 or 10, wherein the polyoxymethylene copolymer has a melt index of from 0.5 to 5 g/10 min.

17. The method for producing a polyoxymethylene-made stretched product as claimed in claim 9 or 10, wherein the polyoxymethylene copolymer has a branched or cross-linked structure.

18. The method for producing a polyoxymethylene-made stretched product as claimed in claim 9 or 10, wherein the polyoxymethylene copolymer has from 0 to 4 mmol/kg of a hemiformal terminal group.

19. The method for producing a polyoxymethylene-made stretched product as claimed in claim 9 or 10, wherein the sectional area of the stretched product is from 0.005 to 300 mm².
